(19) United States
(12) Patent Application Publication
(10) Pub. No.: US 2008/0199707 A1
(43) Pub. Date: Aug. 21, 2008

(54) Method and apparatus for producing an inorganic calcined substance

(75) Inventor: Hidenori Kawai, Chita-shi (JP)

Correspondence Address: BIRCH STEWART KOLASCH & BIRCH, PO BOX 747, FALLS CHURCH, VA, 22040-0747, US

(73) Assignee: NICHIHA CORPORATION, Nagoya-shi (JP)

(21) Appl. No.: 12/068,961

(22) Filed: Feb. 13, 2008

(30) Foreign Application Priority Data
Feb. 15, 2007 (JP) 2007-034208

(51) Int. Cl. B32B 9/04; B29C 43/30

(52) U.S. Cl. 428/428; 264/241; 425/112

(57) ABSTRACT

A method for producing a large sized inorganic calcined substance with good properties using dry press-molding or semi-dry press-molding. The method uses a press machine having an upper plate, a lower plate, and a frame portion, and includes the following steps: a first step of positioning a raw material mixture for forming a rear surface layer or a front surface layer over the lower plate, a second step of positioning a raw material mixture for forming a core layer over the raw material mixture of the first step, a third step of positioning a raw material mixture for forming a front surface layer or a rear surface layer over the raw material mixture of the second step to form a stack of three layers of raw material mixture, and press-molding the stacked three layers of raw material mixture to form a press-molded article using the lower plate and the upper plate.

This non-provisional application claims priority under 35 U.S.C. 119(a)-(d) on Application No. 2007-034208 filed in Japan on Feb. 15, 2007

### FIELD OF THE INVENTION

The present invention relates to a method for producing an inorganic calcined substance comprising a hydraulic inorganic material, a vitreous material, an aggregate and a reinforcing fiber as primary components.

### BACKGROUND OF THE INVENTION

Calcined substances such as tiles have been produced using an extrusion molding method, wet press molding and the like. In the extrusion molding method, extruding can be made easier by using a raw material containing a lubricating component such as a clay. Also in the wet press molding method, a block made of a homogeneous raw material containing a lubricating component such as clay and an appropriate amount of water is pressed with high-pressure using a dehydrating press to form a molded article. For example, JP 06-345529A discloses a method for producing a calcined board for building materials comprising the steps of: preparing a slurry containing a siliceous raw material, a calcareous raw material (cement), and a vitreous material as a primary component; molding the slurry using a cylindrical mold to make a molded article; curing the molded article by autoclave; and then calcinating the cured molded article.

JP 06-144923A discloses a method for producing a pottery and porcelain product by extruding a raw material containing a cement, an inorganic powder and a silica sand to make a molded article, and hardening and then calcinating the molded article to obtain a pottery and porcelain product.

As a molding method for molding a tile, there are a dry press molding method and a semi-dry press molding method in addition to the above-mentioned extrusion molding and wet press molding methods. In the dry press molding method, moisture is provided after molding. In the semi-dry press molding method, a raw material with extremely low moisture is used. Generally, in these methods, blending is made using only powdered raw material and only a very fine fiber is added as a reinforcing fiber to make a homogeneous raw material. However, when a large sized product is prepared, the use of powder material and fine fiber is not enough to avoid problems with shape retainability and/or productivity. Therefore, dry press molding and semi-dry press molding have been used only for producing a tile that is not large sized.

### BRIEF SUMMARY OF THE INVENTION

The present invention has been conceived based on consideration of the above problem. An object of the present invention is therefore to provide a method for producing a large sized calcined substance with good properties using dry press molding or semi-dry press molding. Preferably the large sized calcined substance is 500 mm×1000 mm to 1000 mm×3000 mm.

To accomplish the above objects is an embodiment of the present invention which is a method for producing an inorganic calcined substance, using a press machine having an upper plate, a lower plate, and a frame portion, comprising: a first step of positioning a raw material mixture for forming a rear surface layer or a front surface layer over the lower plate, a second step of positioning a raw material mixture for forming a core layer over the raw material mixture positioned at the first step (i.e., over the positioned raw material mixture for forming the rear surface layer or the front surface layer); and a third step of positioning a raw material mixture for forming a front surface layer or a rear surface layer over the raw material mixture positioned at the second step (i.e., over the positioned raw material mixture for forming the core layer) thereby forming a stack of three layers of the raw material mixture. The stack of three layers of the raw material mixture to is press-molded form a press-molded article using the lower plate and the upper plate.

In an embodiment, the method further includes a surface smoothing step for smoothing a surface of the positioned raw material mixture after the first, second and/or third positioning step.

In an embodiment, the method further includes a step of glazing the press-molded article and a step of calcining the glazed press-molded article after the press-molding step.

An embodiment of the present invention is a method for producing an inorganic calcined substance, using a press machine comprising three parts, i.e. an upper plate, a lower plate and a frame portion; wherein the method comprises: a first step of positioning a raw material mixture for forming a rear surface layer or a front surface layer over the lower plate, positioning an upper edge of the frame portion at the level of the surface of the raw material mixture positioned at the first step by moving the lower plate and/or the frame portion in a vertical direction, smoothing the surface of the raw material mixture positioned at the first step by moving a smoothing member along the upper edge of the frame portion; a second step of positioning a raw material mixture for forming a core layer over the smoothed surface of the raw material mixture positioned at the first step, positioning an upper edge of the frame portion at the level of the surface of the raw material mixture positioned at the second step by moving the lower plate and/or the frame portion in a vertical direction, smoothing the surface of the raw material mixture positioned at the second step by moving a smoothing member along the upper edge of the frame portion; and a third step of positioning a raw material mixture for forming a front surface layer or a rear surface layer over the smoothed surface of the raw material mixture positioned at the second step to form piled three layers of raw material mixture, positioning an upper edge of the frame portion at the level of the surface of the raw material mixture positioned at the third step by moving the lower plate and/or the frame portion in a vertical direction, smoothing the surface of the raw material mixture positioned at the third step by moving a smoothing member along the upper edge of the frame portion, and press-molding the stacked three layers of raw material mixture to form a press-molded article using the lower plate and the upper plate.

In an embodiment of the inventive method for producing an inorganic calcined substance, a smoothing member integrated with a raw material feeding member is used as the smoothing member.

In an embodiment, the raw material mixture for forming a rear surface layer or a front surface layer comprises, as primary components (i.e., is in a concentration of at least 50 weight % based on the weight of the raw material composition), a hydraulic inorganic material, a vitreous material, an aggregate and a reinforcing fiber, and wherein the raw material for forming a core layer comprises, as primary components (i.e., is in a concentration of at least 50 weight % based on the weight of the raw material composition), a hydraulic inorganic material, a vitreous material, an aggregate, a reinforcing fiber and a combustible organic component.

In an embodiment of the present invention, the press-molding is performed in three steps or more.

According to the method of the present invention, a large size calcined substance with good properties can be made by using dry press molding or semi-dry press molding.

### BRIEF DESCRIPTION OF THE DRAWINGS

The attached figures are preferred nonlimiting embodiments which show the steps of the process using the inventive apparatus and are as follows:

FIG. 1 is a front sectional view of a press machine in the standby state used for the present invention;

FIG. 2 is a front sectional view of a press machine used for the present invention where a raw material mixture for the front/rear layer is fed into a raw material feeding member moving onto a lower plate of the press machine;

FIG. 3 is a front sectional view of a press machine used for the present invention where the raw material mixture for the front/rear layer in the raw material feeding member is set on a lower plate of the press machine;

FIG. 4 is a front sectional view of a press machine used for the present invention where the raw material mixture for the front/rear layer is dropped from the raw material feeding member on a lower plate of the press machine as the lower plate moves down to form a cavity constituted by the top surface of the lower plate and the sides of the frame portion facing inward towards the lower plate;

FIG. 5 is a front sectional view of a press machine used for the present invention where the raw material feeding member is moved back to the home position while smoothing the surface of a raw material mixture for the front/rear layer with a smoothing member;

FIG. 6 is a front sectional view of a press machine used for the present invention where a raw material mixture for the core layer is fed into a raw material feeding member and is moved onto a lower plate of the press machine;

FIG. 7 is a front sectional view of a press machine used for the present invention where the raw material mixture for the core layer and front/rear layer are dropped from the raw material feeding member as the lower plate further moves down;

FIG. 8 is a front sectional view of a press machine used for the present invention where the raw material feeding member is moved back to the home position while smoothing the surface of a raw material mixture for the core layer by smoothing member;

FIG. 9 is a front sectional view of a press machine used for the present invention where another raw material mixture for the front/rear layer is fed into a raw material feeding member and is moved onto a lower plate of the press machine;

FIG. 10 is a front sectional view of a press machine used for the present invention where the raw material feeding member is moved back to the home position while smoothing the surface of the raw material mixture for the front/rear layer with a smoothing member;

FIG. 11 is a front sectional view of a press machine used for the present invention where the stacked three layers are press-molded as the upper plate moves down to the lower plate;

FIG. 12 is a front sectional view of a press machine used for the present invention where the upper plate is moved up to release the press-molded three-layered article while the press-molded three layer article is pushed out of the cavity as the lower plate moves up;

FIG. 13 is a perspective view of a specific raw material feeding member integrated with a smoothing member; and

FIG. 14 is a perspective view of another smoothing member used for the present invention.

### DETAILED DESCRIPTION OF THE PRESENT INVENTION

Preferred embodiments of the present invention are described below.

The inorganic calcined substance made by a method of the present invention comprises a hydraulic inorganic material, a vitreous material, an aggregate and a reinforcing fiber as primary components.

### [Hydraulic Inorganic Material]

The hydraulic material is a material which can be hardened by a hydration reaction when it comes into contact with water, and includes at least one of a cement such as normal portland cement, early-strength cement, alumina cement, blast furnace slag cement or fly-ash cement; a slag such as blast furnace slag and/or electric furnace oxidized slag; a lime such as hydrated lime (calcium hydroxide) and/or calcined lime (calcium oxide); gypsum or magnesium carbonate or mixtures thereof. A combination of a blast furnace slag and a hydrated lime is preferable as the hydraulic inorganic material used for this invention. It is particularly preferable to use a non-gypsum slag as blast furnace slag.

### [Vitreous Material]

The vitreous material is a material, which can be melted at calcination to function as a binder, and includes at least one of Shirasu, fly ash, KOUKA-SEKI (a kind of rhyolite), powdered glass and crushed glass sheet. A glass having a low melting point such as a softening temperature of 900° C. or less is preferable as the vitreous material used for this invention. As a low melting point glass, there is a glass with a high content of a low melting point component such as PbO, B₂O₃ and/or ZnO. For example, powdered E glass having a softening point of 840° C. and melting point of 1200° C. is a preferred low melting point glass. E-glass, i.e., electrical glass, is a glass fiber powder having an average grain size of about 30 μm, and the main components are SiO₂ at about 54 weight %, Al₂O₃ at about 15 weight %, CaO at about 23 weight %, B₂O₃ at about 7 weight %. When the vitreous material contains B₂O₃, this provides a low melting point so that low temperature calcinations at around 1000° C. can be made.

### [Aggregate]

An aggregate used for the present invention is a non-plastic material and/or a solvent material and/or an inorganic lightweight material. The non-plastic material is a material for preventing a crack and a distortion caused by a shrink occurring at calcining, and for providing mechanical strength by forming a glass phase through a reaction with alkali. Examples of which include at least one of silica, diatomaceous earth, “Kira” (which is a waste derived from purification process by elutriation of Gairome clay, the waste contains a small amount of feldspar, mica, iron oxide and clay component), silica fume, pyrophyllite, chamotte and the like. Silica powder is preferably used as the non-plastic material in the invention. The solvent material is a base material capable of forming a glass phase at lower temperatures (such as 800-1000° C.) in a calcination process, where the plastic material and the non-plastic material can be dissolved in the glass phase. Examples of the solvent material include at least one of pottery stone and feldspar. Pottery stone powder is preferably used as a non-plastic material in the invention. The inorganic lightweight material can make the molded article lighter and includes at least one of Shirasu balloon, fly-ash balloon and perlite. Perlite is preferably used as the inorganic lightweight material in the invention. Further, at least one of Kaolin, halloysite, Kibushi clay, Gairome clay, sericite, bentonite, and dolomite can be used as a plastic material.

### [Reinforcing Fiber]

A reinforcing fiber used for the present invention includes an inorganic fiber and/or an organic fiber. The inorganic fiber includes at least one of a mineral fiber such as Wollastonite and Sepiolite, a metal fiber such as steel fiber and stainless fiber, a glass fiber and a ceramic fiber. Wollastonite is preferably used as the inorganic fiber in the invention. Wollastonite has a larger aspect ratio than other common reinforcing fibers and is capable of improving dispersibility of the raw material mixture thereby making the raw-material-positioning operation easier and better, which provides better shape retainability and ease of cutting of the molded article. It is preferable to use Wollastonite having an average fiber length of 600 μm or more, preferably about 600 μm and an average fiber diameter of 40 μm or less, preferably about 40 μm. The organic fiber includes at least one of a polyester fiber, polyamide fiber, polypropylene fiber, acrylic fiber and vinylon fiber. It is preferable to use polypropylene fiber or vinylon fiber in this invention. Since these organic fibers burn away while being calcined, the organic fiber can also be a combustible organic component which is to be described in the next paragraph. These organic fibers contribute to shape retainability at press molding of the raw material mixture.

### [Combustible Organic Component]

The combustible organic component is a material which can burn away at calcination temperatures to form a porous structure. The combustible organic component includes at least one of a wood-based material such as wood flour, wood chip, wood wool, wood fiber, pulp, wood fiber bundle and wood fiber; the above-mentioned organic fiber; an organic foam such as expanded polystyrene beads and/or expanded polypropylene beads; and a resin powder of polypropylene and/or polyethylene, and a water-soluble resin such as polyvinyl alcohol resin. As a particularly preferred combustible organic component, a combination of expanded polypropylene beads and polyvinyl alcohol resin can be used. The polypropylene beads form a porous structure and the polyvinyl alcohol resin provides shape retainability during the press molding process.

### [Other Components]

Other components can be used for the raw material mixtures of the invention, and include a waste product that can be recycled and a pigment. The recyclable waste product used in the invention is a crushed inorganic calcined substance and/or a crushed inorganic non-calcined substance. The crushed inorganic calcined substance includes at least one of a crushed material from a defective product; a waste end portion; a product of the inorganic calcined substance produced by the method of the present invention; and from pottery tile shards. As the crushed inorganic calcined substance, it is preferred to use the above-mentioned crushed material of the inorganic calcined substance or pottery tile shards. The crushed inorganic non-calcined substance includes a crushed material of a partly-finished product which was found to be defective at the step after press molding but before calcination and a crushed material of waste wood cement board. A wood cement board is made by molding a raw material mixture containing a wooden material such as wood chips and wood pulp, a hydraulic inorganic material such as Portland cement and a siliceous raw material such as silica sand, and hardening/curing the molded board. The wooden material contained in the crushed material functions as a combustible organic component. Other components in the wood cement board function as an aggregate since they are not calcined. These recyclable waste products are crushed to grains having 10-100 μm size. As a pigment, for example, at least one of titanium oxide, zinc oxide, carbon black or colcothar can be added when needed.

### [Composition of Raw Materials Used for the Total Inorganic Calcined Substance]

The composition of the raw material for the inorganic calcined substance to be made by the method of the present invention is now discussed. Based on the total solid content, a hydraulic inorganic material accounts for 15-35 weight %, a vitreous material accounts for 1-15 weight %, an aggregate accounts for 5-45 weight %, a reinforcing fiber accounts for 15-35 weight %, a combustible organic component accounts for 0.2-10 weight % and a recyclable waste product accounts for 5-50 weight %. If the hydraulic inorganic material content is less than 15 weight %, the initial mechanical strength becomes so low that the shape may not be retained. If the content exceeds 35 weight %, a hydration reaction will proceed beyond that which is needed thereby making the sintering at the calcination process difficult. If the vitreous material content is less than 1 weight %, sintering during calcination cannot be completed. If the content exceeds 15 weight %, the warp becomes large as shrinkage occurring at the calcination process becomes large. If the aggregate content is less than 5 weight %, the strength becomes poor. If the content exceeds 45 weight %, shape retainability during the press molding process becomes poor. If the reinforcing fiber content is less than 15 weight %, the physical properties such as strength may become poor. If the content exceeds 35 weight %, the product can become too bulky. If the combustible organic component content is less than 0.2 weight %, it is difficult to form a porous structure as it is burned away. If the content exceeds 10 weight %, an excess porosity will form, which leads to deterioration of properties. If the recyclable waste product content is less than 5 weight %, economic usefulness is declined. If the content exceeds 50 weight %, strength is extremely lowered.

### [Composition of the Raw Material Mixture for Front/Rear Layer]

The inorganic calcined substance is made of three layers, i.e., a front layer, rear layer and a core layer. It is preferred that the front and rear layers have the same composition (hereinafter referred to as front/rear layer) and which is different from the composition of the core layer. The front/rear layer preferably comprises, based on the total sold content, a hydraulic inorganic material at 15-35 weight %, a vitreous material at 1-15 weight %, a non-plastic material at 2.5-27.5 weight % and a solvent material at 2.5-27.5 weight % as an aggregate, an inorganic fiber at 12-34.9 weight %, an organic fiber at 0.1-3 weight % as a reinforcing fiber, a water-soluble resin as a combustible organic component at 0.1-3 weight %, and a crushed inorganic calcined substance and/or a crushed inorganic non-calcined substance as a recyclable waste product at 5-50 weight %.

### [Composition of Raw Materials Mixture for the Core Layer]

The core layer preferably comprises, based on the total solid content, a hydraulic inorganic material at 15-35 weight %, a vitreous material at 1-15 weight %, an inorganic lightweight material as an aggregate at 4-45 weight %, an inorganic fiber at 12-34.9 weight %, an organic fiber at 0.1-3 weight % as reinforcing fiber, an organic lightweight material at 0.1-3 weight %, a water-soluble resin at 0.1-3 weight % as a combustible organic component, and a crushed inorganic calcined substance and/or a crushed inorganic non-calcined substance as a recyclable waste product at 5-50 weight %.

### [Press Machine]

A press machine is described in reference to the appended figures.

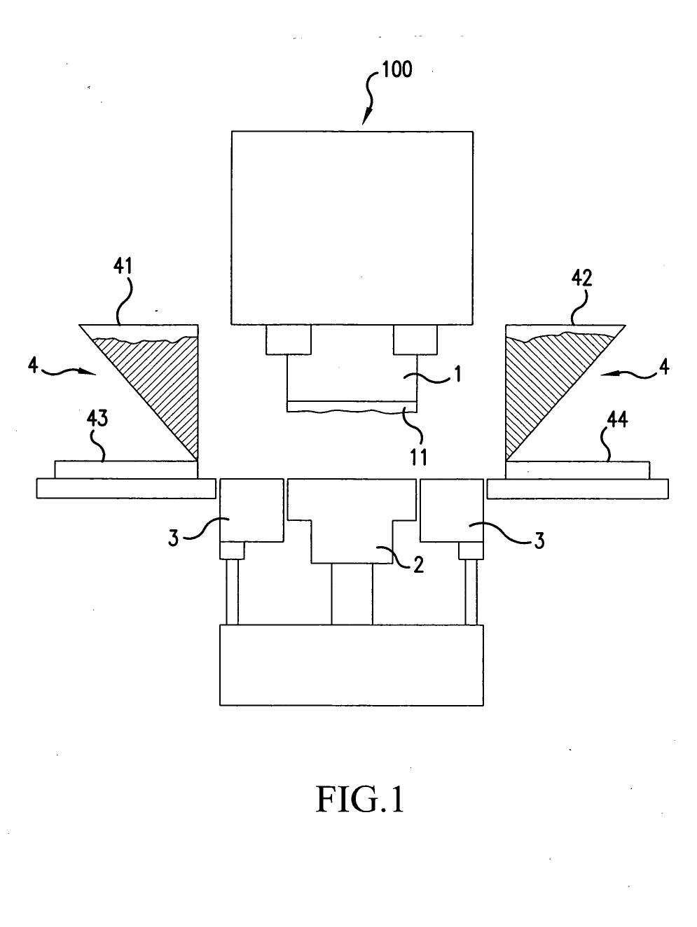

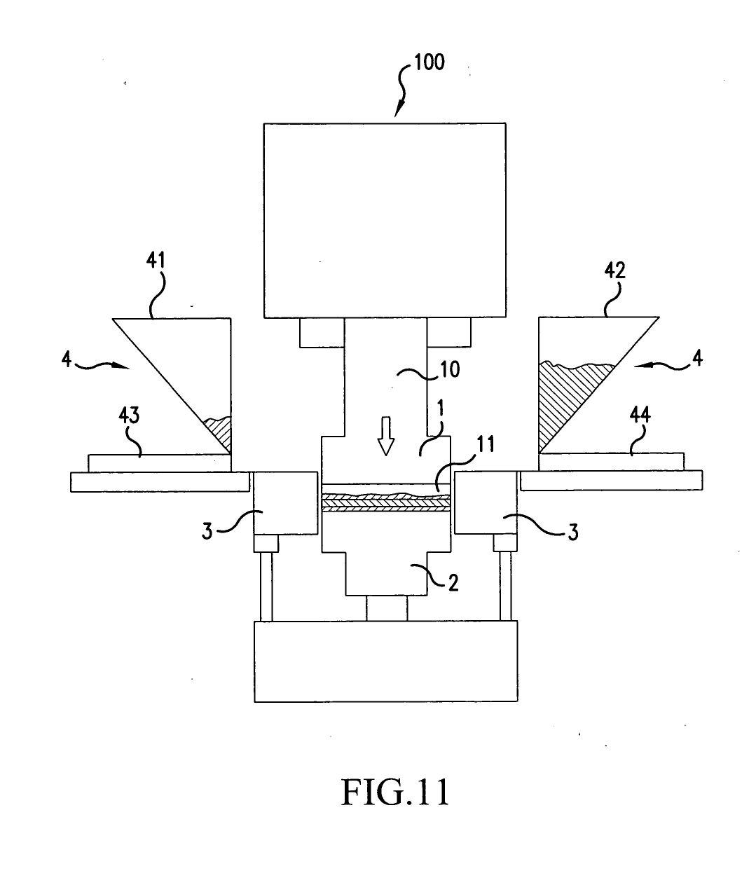

As shown in FIG. 1, a press machine (100) to be used in the method of the present invention has an upper plate (1), a lower plate (2) and a frame portion (3). The upper plate (1) is coupled to a press cylinder (10) (press cylinder (10) is shown in FIG. 11) so as to move up and down. A material is press-molded between the upper plate (1) and the lower plate (2) by moving down the upper plate (1). Preferably the upper plate (1) has an embossing plate (11) attached on the bottom face for embossing the surface of the press-molded material. The embossing plate (11) is preferably made of metal. The frame portion (3) and the lower plate (2) are also movable up and down. By moving up the frame portion (3) or moving down the lower plate (2), a cavity can be formed between the frame portion and the lower plate. A raw material of inorganic calcined substance is positioned in the cavity to be press-molded. The press machine is equipped with a raw material feeder (4) which is located outside of the moving space of the press cylinder (10). The raw material feeder (4) comprises raw material feeding hoppers (41, 42) and raw material feeding members (43, 44). Raw material mixtures for the core layer and for the front/rear layer are stored in the hoppers (41, 42). With respect to the inorganic calcined substance with three-layer structure of this invention, it is preferable to have two hoppers, i.e., hopper (41) for the raw material for the front/rear layer and hopper (42) for the raw material for the core layer. Feeding from the hoppers (41, 42) is controlled by a valve (not shown) at the exit of the hopper. Each of the raw material feeding members (43, 44) has a frame structure. It is preferable to have two feeding members, i.e., a member for the raw material for the front/rear layer and another member for the raw material for the core layer in order to shorten the time for positioning the raw material. A lower edge of the frame of the raw material feeding member can function as a smoothing member (5). The smoothing member (5) can be formed by an indentation in the lower edge of the frame or the smoothing member (5) can be formed of plastic, thermo-setting resin or rubber. Further, a vibrator can be attached to the raw material feeding members (43, 44).

### [Producing Method]

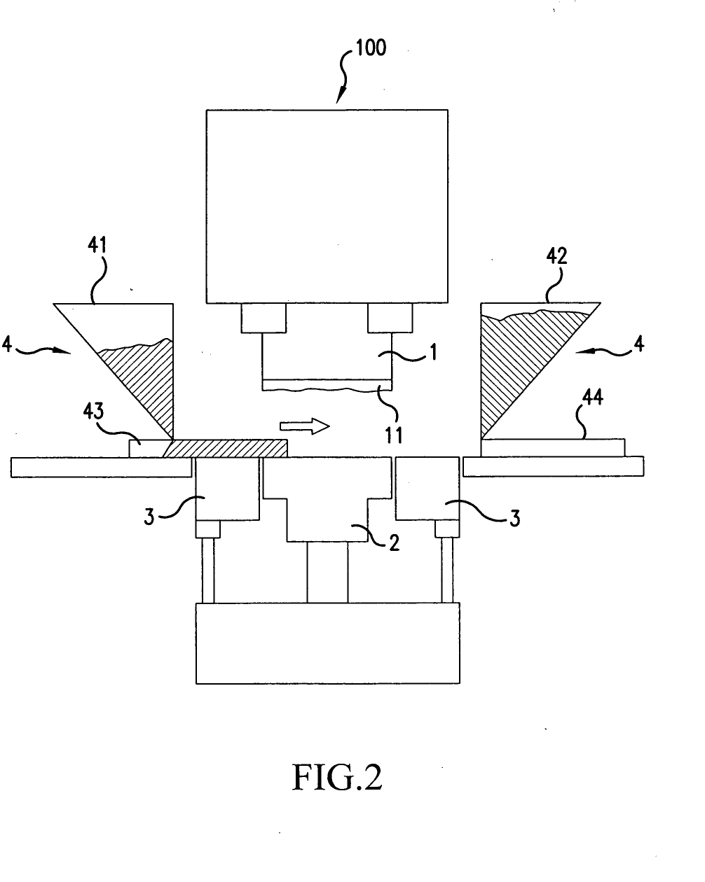

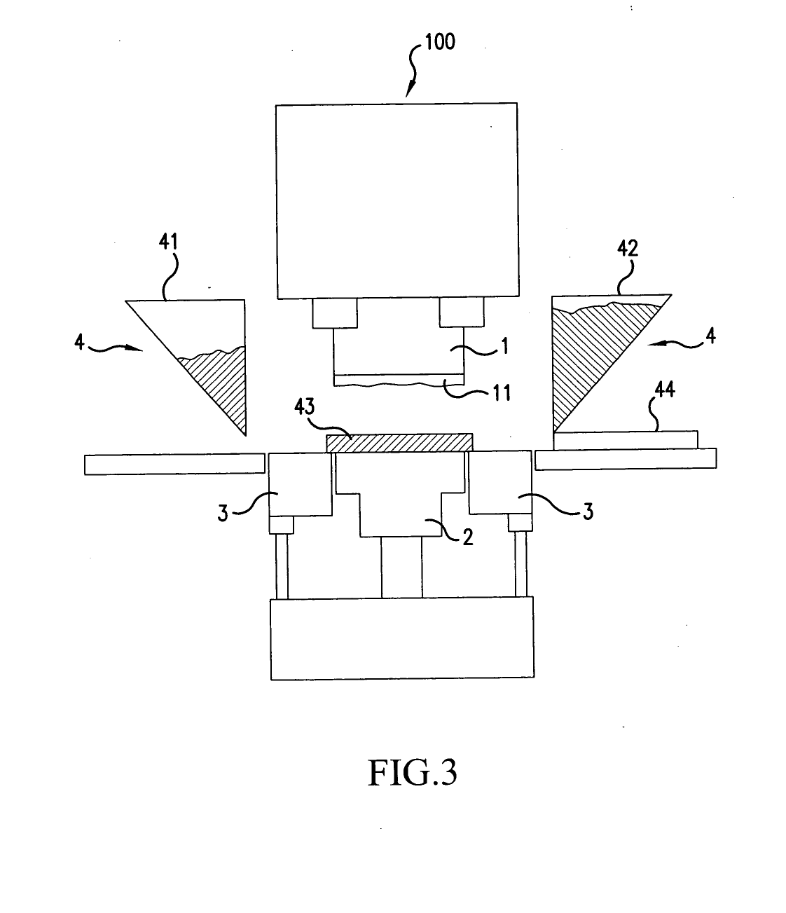

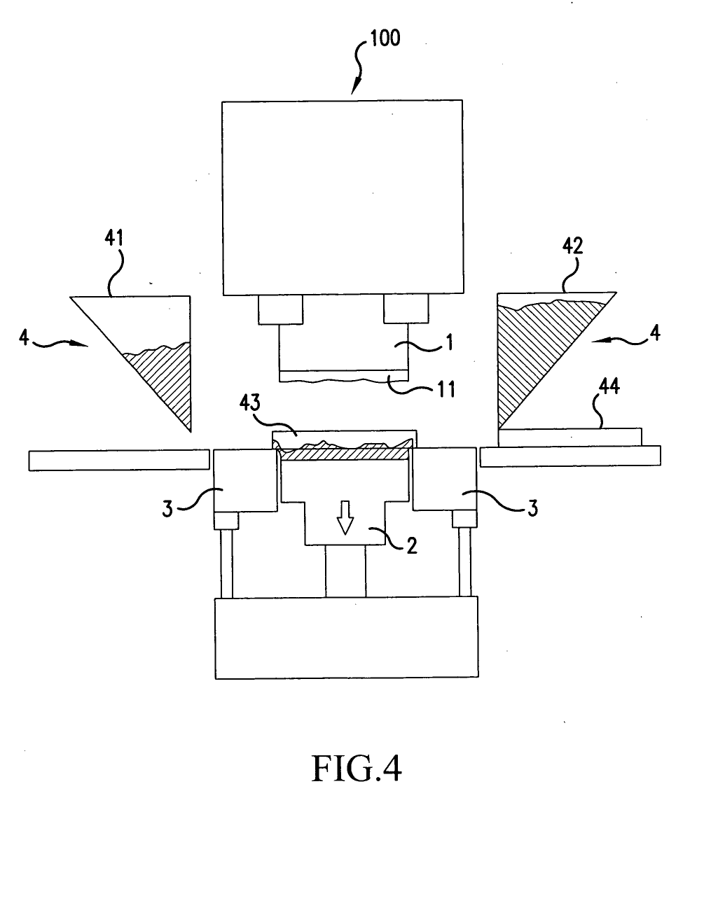

A method for producing an inorganic calcined substance of the present invention is now described. First, a raw material mixture for the front/rear layer comprising a hydraulic inorganic material, a vitreous material, an aggregate and a reinforcing fiber as a primary component is stored in a raw material feeding hopper (41); and a raw material mixture for the core layer comprising a hydraulic inorganic material, a vitreous material, an aggregate, a reinforcing fiber and a combustible organic component as a primary component is stored in a raw material feeding hopper (42). Second, as shown in FIG. 2, the raw material mixture for front/rear layer in the raw material feeding hopper (41) is fed to the raw material feeding members (43). Third, as shown in FIG. 3, the raw material feeding member (43) is moved to a location over the lower plate (2). Fourth, as shown in FIG. 4, the lower plate (2) is moved down. The raw material feeding member (43) is larger in size than the lower plate (2) so that the feeding member (43) can stay on the frame portion (3) without moving down when the lower plate (2) moves down. The raw material feeding member (43) is constituted by frames with an open bottom. Therefore, the raw material mixture in the feeding member (43) over the lower plate (2) is positioned (similar to a dropping or sprinkling of the material) as it fills the cavity formed by the lower plate (2) and the frame portion (3) as the lower plate goes down. The raw material mixture comprises a fiber content, therefore, the surface of the positioned mixture tends to not be so smooth, but rather bumpy since the fiber and powdered material agglomerates. (When the mixture does not contain a fiber but contains only powdered material, the surface can be smoother.) If another raw material is positioned over this bumpy surface, the final product may have problems such as a non-uniform distribution in thickness, e.g., a tapered board, and a non-uniform distribution in specific gravity. In view of this, it is preferred to smooth the surface of the positioned material, which can be performed with the smoothing member (5).

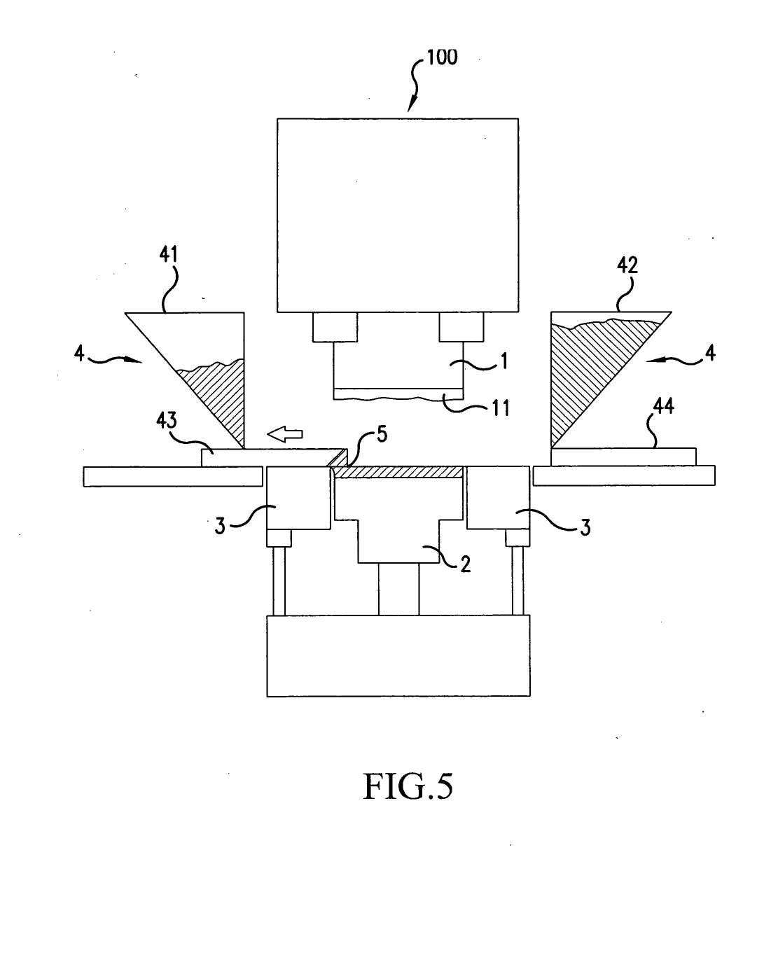

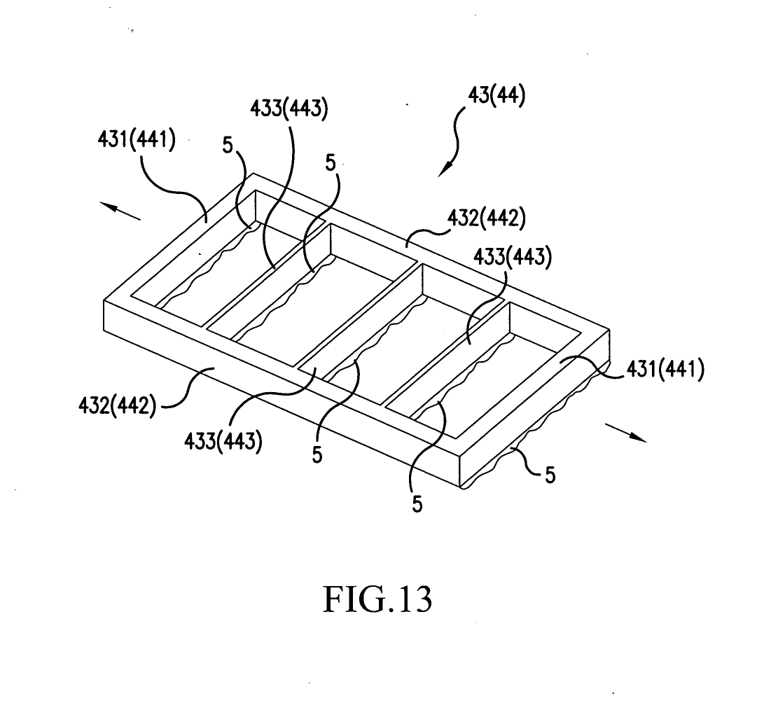

FIG. 13 shows an example of a raw material feeding member (43). (A pair of feeding members (43) and (44) is used in the invention. The feeding member (44) is the same as the feeding member (43) in structure. Therefore, the description is hereinafter made with respect to only one member of the pair, i.e., (43)). A raw material feeding member (43) has an outer rectangular frame, which comprises a pair of lateral frames (431, 431) disposed perpendicular to the moving direction and a pair of longitudinal frames (432, 432) disposed parallel to the moving direction, and an inner lateral frame (433) disposed perpendicular to the moving direction. The smoothing member (5) is formed on at least one of the lateral frames (431). The inner lateral frame (433) can also have a smoothing member (5). As shown in FIG. 13, the area inside the outer rectangular frame is separated by the inner frames into smaller areas. This structure makes it possible to feed a raw material to the raw material feeding member (43) without having non-uniformity inside the outer rectangular frame and it also makes it possible to uniformly sprinkle the raw material into the cavity without a local fluctuation in the fed amount as the raw material is fed little by little. As shown in FIG. 5, after all the raw material is dropped from the feeding member (43) into the cavity formed with the lower plate (2) and the frame portion (3), the feeding member (43) moves back to the original position (home position) under the raw material feeding hopper (41) while smoothing the bumpy surface of the raw material in the cavity with the smoothing member (5). Thus, the surface can be smoothed without using another smoothing device in the next step.

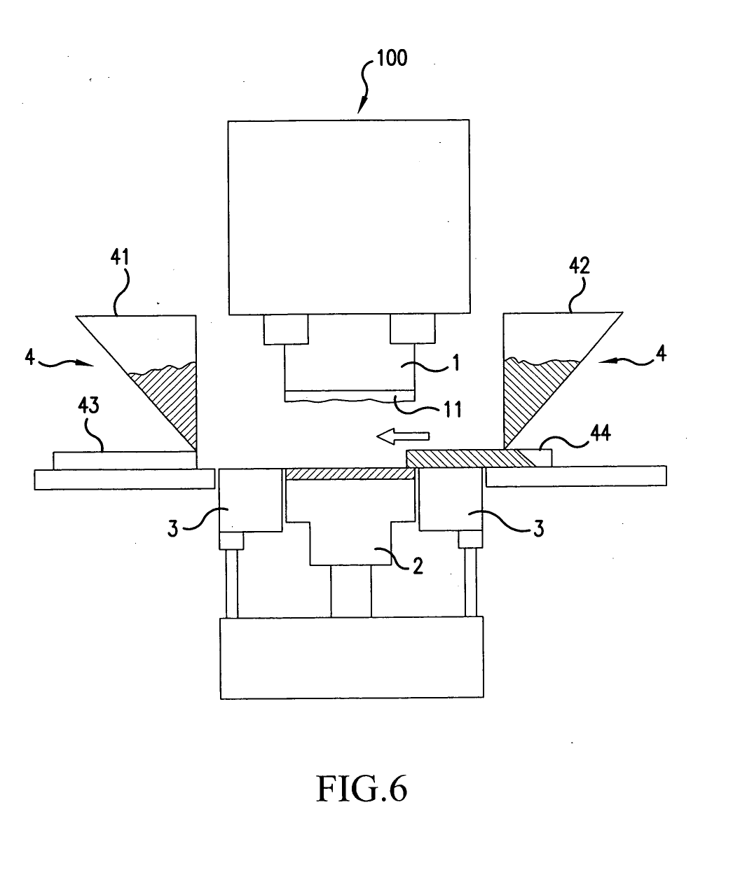

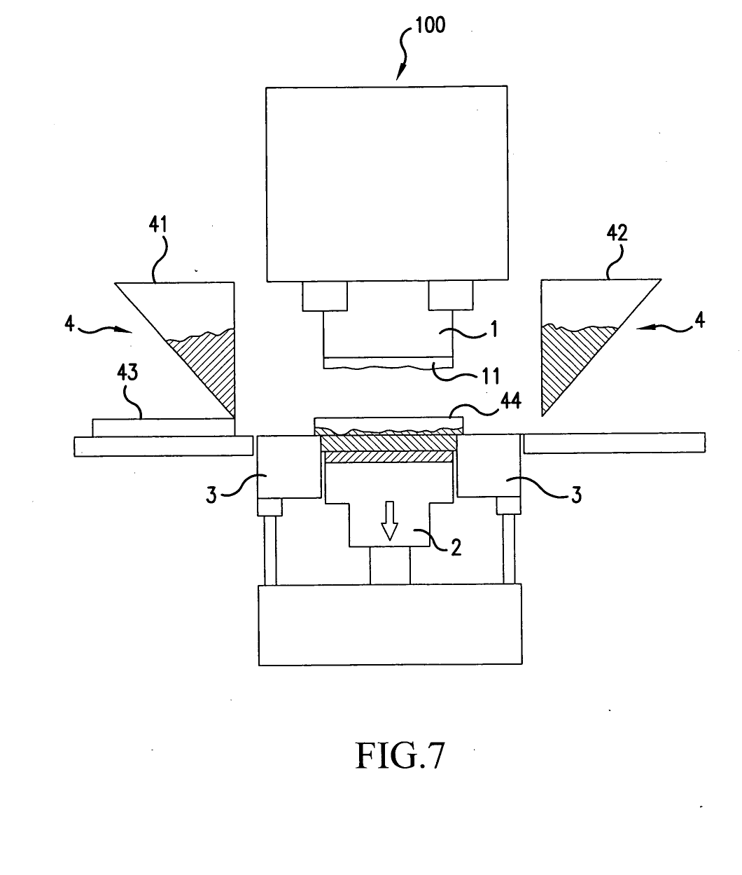

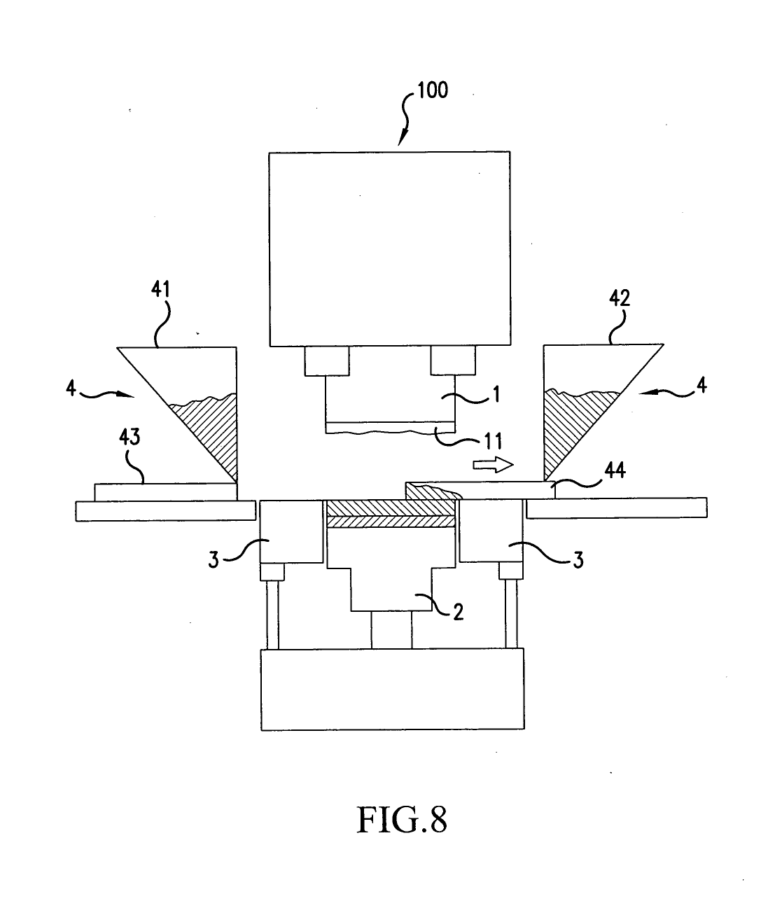

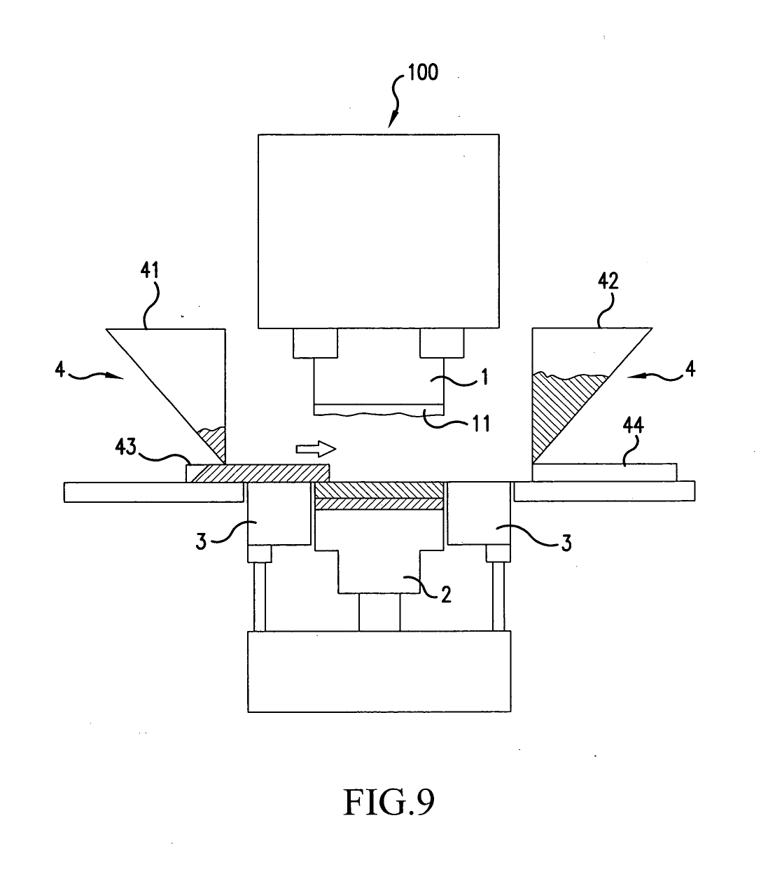

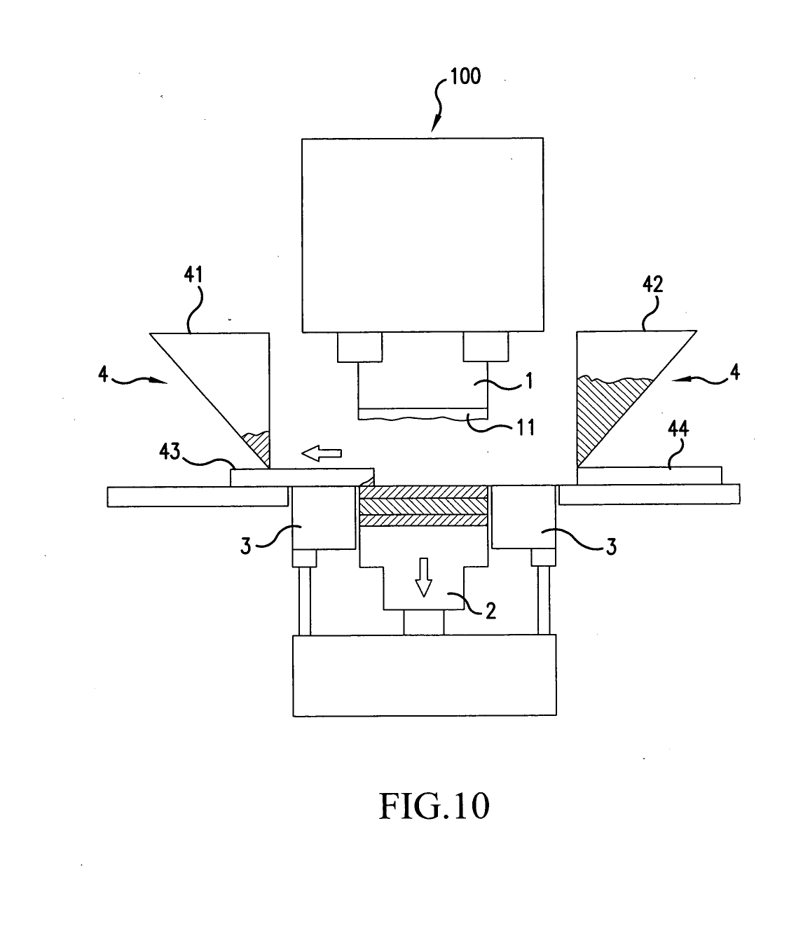

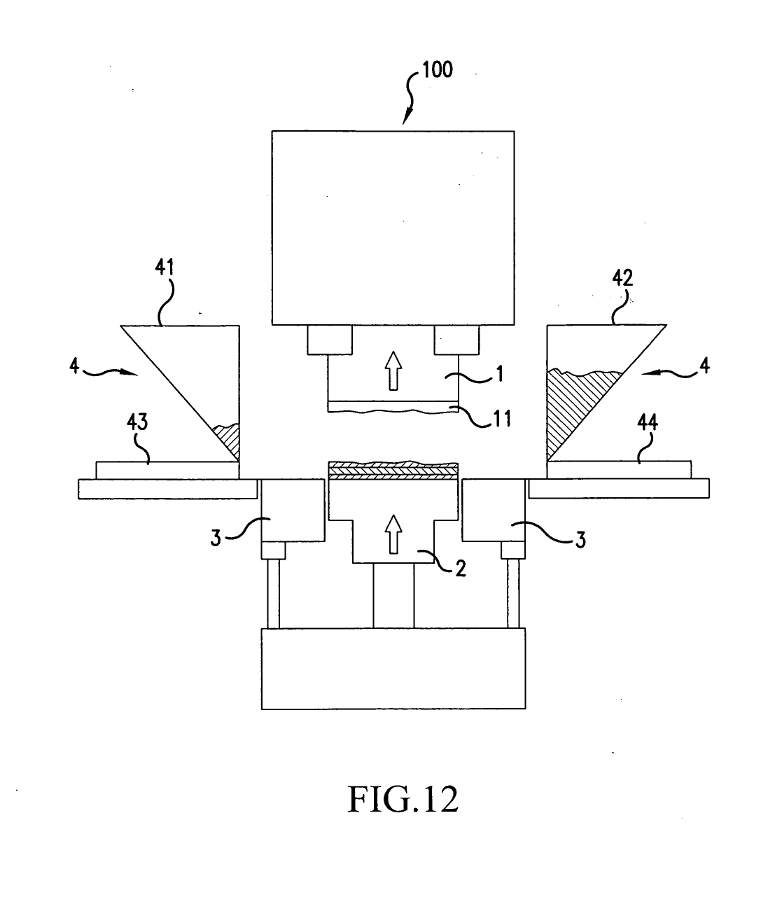

FIGS. 6-10 depict the process steps after FIG. 5 wherein one front/rear layer is formed. In FIGS. 6-10, a raw material mixture for the core layer and then a raw material mixture for another front/rear layer are fed in turn in the cavity over the first front/rear layer in the same manner as was used to form the first front/rear layer to form a stack of three layers. Then, as shown in FIGS. 11 and 12, the piled three layers are press-molded between the upper plate (1) and the lower plate (2) as the upper plate (1) moves down, and then the upper plate (1) moves up to release the press-molded three layer stack. This press-molding is preferably performed by three steps or more. The raw material mixture used for the invention contains a reinforcing fiber, which causes the mixture to hold a fair amount of air in the fibers or in the agglomerate of fibers and powdered raw material. If the press-molding is performed all at once to obtain a press-molded article, the held air cannot be released sufficiently and functions as an air cushion. The air cushion portion cannot be press-molded, which leads to breakage from the surface of press-molded article. To avoid this, press-molding is performed stepwise. The air can be released through the clearance between the upper plate (1) and the frame portion (3) by holding the press condition for some time at each step. The applied pressure is preferably from 0.5 to 30 MPa and the holding time is preferably from 5 to 180 second. Thus, the press molded article is obtained.

The press molded article is glazed and calcined. Calcination is carried out at 1100-1250° C. for 1-3 hours. Calcination is preferably performed using a continuous calcination furnace. An inorganic calcined substance, thus obtained is used as building material such as an external wall material.

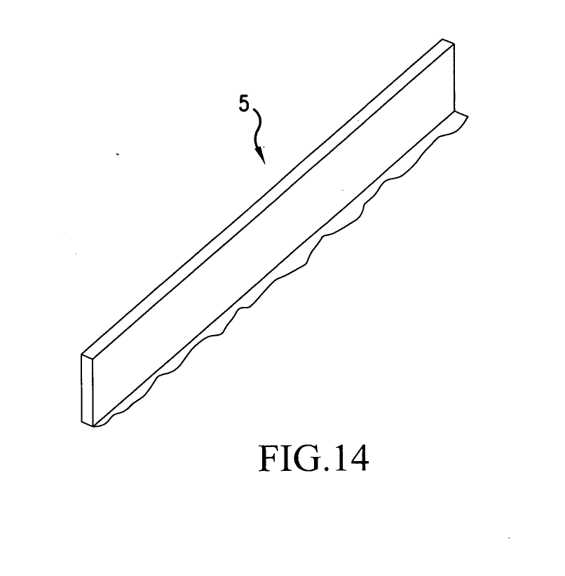

The following is another method of the present invention for preparing three layer stacks. First, the cavity is formed in advance by moving down the lower plate. Second, a raw material mixture for the front/rear layer or for the core layer is fed into the cavity. Third, the frame portion is moved down so that upper edge of the frame portion is positioned approximately at the level of the surface of the positioned raw material mixture. Fourth, the surface is smoothed by moving a plate-like smoothing member shown in FIG. 14 along the upper edge of the frame portion. By moving the plate-like smoothing member this way, surface portions of the raw material projecting beyond the level of the upper edge of the frame portion is shifted to fill recessed surface portions so that the entire surface of the raw material mixture inside the frame portion is positioned at the same level as the upper edge of the frame portion. Then, after the frame portion is moved up to the original position (home position), the same operation is repeated to prepare another layer.

It is possible to provide a smooth surface of the raw material mixture in the cavity by applying a mechanical vibration if the fed raw material is made of only powdered material. The raw material used for the present invention, however, contains a reinforcing fiber and an appropriate amount of water in addition to the powdered raw material. In order to smooth the surface of such raw material only by applying a vibration, a strong vibration or lengthy weak vibration is required. However, the strong vibration or lengthy weak vibration works to separate the powdered material from the reinforcing fiber, and the surface portion becomes rich in the reinforcing fiber and the mid-portion or bottom portion becomes rich in the powdered raw material, which leads to undesired properties including fluctuation of the specific gravity of the block. Using a weak vibration that is not lengthy can make the raw material more uniform as a whole, which is preferable. In view of this, a vibrator can be attached to the raw material feeding member to apply the weak vibration to the raw material.

### EXAMPLES

Examples of the present invention are described below.

Examples 1-6 and comparison examples 1-6 were carried out to form the raw material compositions and using the manufacturing conditions shown in Table 1 and Table 2. The applied press pressure was 0.5-30 MPa, and calcination was performed at 1100-1250° C. for 1-3 hours. The properties of the resultant calcined substances are shown in Table 3 and Table 4. The bending stress was measured pursuant to JIS A 1408. The rate of freezing thawing resistance test is a measure of the swelling in the thickness direction by freezing and thawing after performing 600 cycles using freezing-in-air/thawing-in-water method pursuant to JIS A 1435. Symbol ◯ represents samples having no problem (good), symbol Δ represents samples where some elongation was found (fair), and symbol X represents samples having an unsatisfactory amount of elongation. Dimensional stability is evaluated by measuring an elongation after 15 days of water absorption. Symbol ◯ represents no problem (good), symbol Δ represents there is some elongation found (fair), and symbol X represents there is fair amount of elongation (bad). The crack resistance was evaluated by visual inspection after being exposed to 10 cycles of a testing process where one cycle consists of 4 hours of water absorption, 4 hours of carbonation (CO₂ concentration is 5%), and drying at 100° C. for 15-16 hours. If no crack was found, evaluation is represented by ◯ (good), a few cracks were found is represented by Δ (fair), and a number of cracks was found is represented by X (unsatisfactory). As for press suitability, symbol ⊚ represents an excellent mold releasability, symbol ◯ represents a good mold releasability, symbol Δ represents fair mold releasability, and symbol X represents such a poor mold releasability that the surface of the molded article is easily peeled off.

TABLE 1
[Examples]

| | | Example 1 | | Example 2 | | Example 3 | | Example 4 | | Example 5 | | Example 6 | |
|---|---|---|---|---|---|---|---|---|---|---|---|---|---|
| | | front/ | | front/ | | front/ | | front/ | | front/ | | front/ | |
| | | rear | core | rear | core | rear | core | rear | core | rear | core | rear | core |
| composition (Weight %) | slag | 24 | 24 | 24 | 24 | 24 | 24 | 24 | 24 | 24 | 24 | 24 | 24 |
| | calcium | 2.7 | 2.7 | 2.7 | 2.7 | 2.7 | 2.7 | 2.7 | 2.7 | 2.5 | 2.5 | 2.7 | 2.7 |
| | hydroxide | | | | | | | | | | | | |
| | E-glass | 10 | 10 | 10 | 10 | 10 | 10 | 10 | 10 | 10 | 10 | 10 | 10 |
| | silica powder | 17.5 | 0 | 17.5 | 0 | 17.5 | 0 | 17.5 | 0 | 17.5 | 0 | 17.5 | 0 |
| | pottery stone | 10 | 0 | 10 | 0 | 10 | 0 | 10 | 0 | 10 | 0 | 10 | 0 |
| | powder | | | | | | | | | | | | |
| | perlite | 0 | 6.5 | 0 | 6.5 | 0 | 6.5 | 0 | 6.5 | 0 | 6.5 | 0 | 6.5 |
| | wollastonite | 25 | 25 | 25 | 25 | 25 | 25 | 25 | 25 | 25 | 25 | 30 | 30 |
| | vinylon fiber | 0.3 | 0.3 | 0.3 | 0.3 | 0.3 | 0.3 | 0.3 | 0.3 | 0.3 | 0.3 | 0.3 | 0.3 |
| | polyvinyl | 0.5 | 0.5 | 0.5 | 0.5 | 0.5 | 0.5 | 0.5 | 0.5 | 0.5 | 0.5 | 0.5 | 0.5 |
| | alcohol resin | | | | | | | | | | | | |
| | expanded resin | 0 | 1 | 0 | 1 | 0 | 1 | 0 | 1 | 0 | 1 | 0 | 1 |
| | beads | | | | | | | | | | | | |
| | pottery tile | 10 | 30 | 10 | 30 | 10 | 30 | 10 | 30 | 10 | 30 | 5 | 25 |
| | shards | | | | | | | | | | | | |
| manufacturing | Smoothing | done | done | done | done | done | done | done | done | done | done | done | done |
| conditions | process | | | | | | | | | | | | |

| | | | | | | |
|---|---|---|---|---|---|---|
| the number of | 1 | 2 | 3 | 5 | 3 | 3 |
| press steps for | | | | | | |
| press-molding | | | | | | |

TABLE 2
[Comparison examples]

| | | Example 1 | | Example 2 | | Example 3 | | Example 4 | | Example 5 | | Example 6 | |
|---|---|---|---|---|---|---|---|---|---|---|---|---|---|
| | | front/ | | front/ | | front/ | | front/ | | front/ | | front/ | |
| | | rear | core | rear | core | rear | core | rear | core | rear | core | rear | core |
| composition (Weight %) | slag | 24 | 24 | 24 | 24 | 24 | 24 | 24 | 24 | 24 | 24 | 32 | 32 |
| | calcium | 2.7 | 2.7 | 2.7 | 2.7 | 2.7 | 2.7 | 2.7 | 2.7 | 3 | 3 | 7 | 7 |
| | hydroxide | | | | | | | | | | | | |
| | E-glass | 10 | 10 | 10 | 10 | 10 | 10 | 10 | 10 | 10 | 10 | 10 | 10 |
| | silica powder | 17.5 | 0 | 17.5 | 0 | 17.5 | 0 | 17.5 | 0 | 17.5 | 0 | 21.5 | 0 |
| | pottery stone | 10 | 0 | 10 | 0 | 10 | 0 | 10 | 0 | 10 | 0 | 14 | 0 |
| | powder | | | | | | | | | | | | |
| | perlite | 0 | 6.5 | 0 | 6.5 | 0 | 6.5 | 0 | 6.5 | 0 | 6.5 | 0 | 14.5 |
| | wollastonite | 25 | 25 | 25 | 25 | 25 | 25 | 25 | 25 | 25 | 25 | 0 | 0 |
| | vinylon fiber | 0.3 | 0.3 | 0.3 | 0.3 | 0.3 | 0.3 | 0.3 | 0.3 | 0 | 0 | 0 | 0 |
| | polyvinyl | 0.5 | 0.5 | 0.5 | 0.5 | 0.5 | 0.5 | 0.5 | 0.5 | 0.5 | 0.5 | 0.5 | 0.5 |
| | alcohol resin | | | | | | | | | | | | |
| | expanded resin | 0 | 1 | 0 | 1 | 0 | 1 | 0 | 1 | 0 | 1 | 0 | 1 |
| | beads | | | | | | | | | | | | |
| | pottery tile | 10 | 30 | 10 | 30 | 10 | 30 | 10 | 30 | 10 | 30 | 15 | 35 |
| | shards | | | | | | | | | | | | |
| manufacturing | Smoothing | Not | Not | Not | Not | done | Not | Not | done | done | done | done | done |
| conditions | process | done | done | done | done | | done | done | | | | | |

| | | | | | | |
|---|---|---|---|---|---|---|
| the number of | 1 | 3 | 3 | 3 | 3 | 3 |
| press steps for | | | | | | |
| press-molding | | | | | | |

TABLE 3
[Properties]

| Properties | Example 1 | Example 2 | Example 3 | Example 4 | Example 5 | Example 6 |
|---|---|---|---|---|---|---|
| absolute dry specific | 1.36 | 1.35 | 1.36 | 1.38 | 1.39 | 1.39 |
| gravity | | | | | | |
| bending strength | 17.2 | 16.9 | 17.0 | 18.5 | 18.4 | 18.7 |
| (N/mm²) | | | | | | |
| dimensional stability | ◯ | ◯ | ◯ | ◯ | ◯ | ◯ |
| freezing thawing | ◯ | ◯ | ◯ | ◯ | ◯ | ◯ |
| resistance | | | | | | |
| crack resistance | ◯ | ◯ | ◯ | ◯ | ◯ | ◯ |
| press suitability | Δ~◯ | ◯ | ◯ | ⊚ | ⊚ | ◯ |

TABLE 4
[Properties]

| | Comparison | Comparison | Comparison | Comparison | Comparison | Comparison |
|---|---|---|---|---|---|---|
| Properties | example 1 | example 2 | example 3 | example 4 | example 5 | example 6 |
| absolute dry specific | 1.25 | 1.30 | 1.35 | 1.34 | 1.32 | 1.29 |
| gravity | | | | | | |
| bending strength | 15.1 | 16.5 | 16.8 | 16.8 | 16.7 | 16.6 |
| (N/mm²) | | | | | | |
| dimensional stability | ◯ | ◯ | ◯ | ◯ | ◯ | ◯ |
| freezing thawing | ◯ | ◯ | ◯ | ◯ | ◯ | ◯ |
| resistance | | | | | | |
| crack resistance | ◯ | ◯ | ◯ | ◯ | ◯ | ◯ |
| press suitability | X | X~Δ | Δ | Δ | X~Δ | X~Δ |

Table 3 shows the followings.

The press suitability of example 1, where the smoothing process was done with both front/rear layers and core layer, and the press-molding was performed by only one step of pressing (reaching the goal pressure value by one step), is evaluated as Δ ˜◯ (between fair and good). The press suitability of example 2, where the smoothing process was done with both front/rear layers and core layer, and the press-molding was performed by two steps of pressing (reaching the goal pressure value by two steps), was evaluated as ◯ (good). The press suitability of example 3, where the smoothing process was done with both front/rear layers and core layer, and the press-molding was performed by three steps of pressing (reaching the goal pressure value by three steps), was evaluated as ◯ (good). The press suitability of example 4, where the smoothing process was done with both front/rear layers and core layer, and the press-molding was performed by five steps of pressing (reaching the goal pressure value by five steps), was evaluated as ⊚ (excellent). The press suitability of example 5, where 0.5 weight % of vinylon fiber was contained in the composition, the smoothing process was done with both front/rear layers and core layer, and the press-molding was performed by three steps of pressing (reaching the goal pressure value by three steps), was evaluated as ⊚ (excellent). The press suitability of example 6, where 30 weight % of Wollastonite was contained in the composition, the smoothing process was done with both front/rear layers and core layer, and the press-molding was performed by three steps of pressing (reaching the goal pressure value by three steps), was evaluated as ◯ (good).

Table 4 shows the followings.

The press suitability of comparison example 1, where the smoothing process was neither done with front/rear layers nor with core layer, and the press-molding was performed by only one step of pressing (reaching the goal pressure value in one step), is evaluated as X (poor). The press suitability of comparison example 2, where the smoothing process was neither done with front/rear layers nor with core layer, and the press-molding was performed by three steps of pressing (reaching the goal pressure value by three steps), is evaluated as X˜Δ (between poor and fair). The press suitability of comparison example 3, where the smoothing process was done with front/rear layers but not with the core layer, and the press-molding was performed by three steps of pressing (reaching the goal pressure value by three steps), is evaluated as Δ (fair). The press suitability of comparison example 4, where the smoothing process was not done with front/rear layers but with core layer, and the press-molding was performed by three steps of pressing (reaching the goal pressure value by three steps), is evaluated as Δ (fair). The press suitability of comparison example 5, where the smoothing process was done with both front/rear layers and core layer, but vinylon fiber was contained neither in the front/rear layers nor in the core layer, is evaluated as X˜Δ (between poor and fair). The press suitability of comparison example 6, where the smoothing process was done with both front/rear layers and core layer, but Wollastonite was contained neither in the front/rear layers nor in the core layer, is evaluated as X˜Δ (between poor and fair).

What is claimed is:

1. A method for producing an inorganic calcined substance using a press machine having an upper plate, a lower plate, and a frame portion, comprising:
a first step of positioning a raw material mixture for forming a rear surface layer or a front surface layer over the lower plate,
a second step of positioning a raw material mixture for forming a core layer over the raw material mixture layer formed at the first step,
a third step of positioning a raw material mixture for forming a front surface layer or a rear surface layer over the raw material mixture layer formed at the second step to form a stack of three layers, and
press-molding the stacked three layers to form a press-molded article with the lower plate and the upper plate.

2. The method according to claim 1, further comprising a step of smoothing a surface of positioned raw material mixture after the first step, after the second step and/or after the third step.

3. The method according to claim 1, further comprising a step of glazing the press-molded article, and a step of calcining the glazed press-molded article after the press-molding step.

4. The method according to claim 2, further comprising a step of glazing the press-molded article, and a step of calcining the glazed press-molded article after the press-molding step.

5. A method for producing an inorganic calcined substance, using a press machine having an upper plate, a lower plate, and a frame portion, comprising:
a first step of positioning a raw material mixture for forming a rear surface layer or a front surface layer over the lower plate,
transferring the raw material mixture to a cavity while forming said cavity by moving the lower plate and/or the frame portion in a vertical direction, wherein said cavity is formed by a top surface of said lower plate and inward sides of the frame portion, and wherein said moving of the lower plate and/or the frame portion in a vertical position is stopped when an upper edge of the frame portion is at a level of a top surface of the raw material mixture of the first step,
smoothing the top surface of the raw material mixture of the first step by moving a smoothing member along an upper edge of the frame portion,
a second step of positioning a raw material mixture for forming a core layer over the smoothed surface of the raw material mixture of the first step,
a step of expanding said cavity by positioning the upper edge of the frame portion at a level of a top surface of the raw material mixture of the second step by moving the lower plate and/or the frame portion in a vertical direction,
smoothing the top surface of the raw material mixture of the second step by moving a smoothing member along the upper edge of the frame portion,
a third step of positioning a raw material mixture for forming a front surface layer or a rear surface layer over the smoothed surface of the raw material mixture of the second step to form a stack of three layers of raw material mixture,
a step of expanding said cavity by positioning an upper edge of the frame portion at a top level of a surface of the raw material mixture of the third step by moving the lower plate and/or the frame portion in vertical direction to form a stack of three layers,
smoothing the top surface of the raw material mixture of the third step by moving a smoothing member along the upper edge of the frame portion, and
press-molding the stack of three layers of raw material mixture to form a press-molded article using the lower plate and the upper plate.

6. The method according to claim 5, wherein the smoothing member is integrated with a raw material feeding member.

7. The method according to claim 5, further comprising a step of glazing the press-molded article, and a step of calcining the glazed press-molded article after the press-molding step.

8. The method according to claim 6, further comprising a step of glazing the press-molded article, and a step of calcining the glazed press-molded article after the press-molding step.

9. The method according to claim 1, wherein the raw material for forming a rear surface layer or a front surface layer comprises a hydraulic inorganic material, a vitreous material, an aggregate and a reinforcing fiber as primary components; and the raw material for forming a core layer comprises a hydraulic inorganic material, a vitreous material, an aggregate, a reinforcing fiber and a combustible organic component as primary components.

10. The method according to claim 1, wherein the press-molding is performed stepwise by three steps or more after each layer of raw material mixture is formed.

11. The method according to claim 5, wherein the raw material for forming a rear surface layer or a front surface layer comprises a hydraulic inorganic material, a vitreous material, an aggregate and a reinforcing fiber as primary components; and the raw material for forming a core layer comprises a hydraulic inorganic material, a vitreous material, an aggregate, a reinforcing fiber and a combustible organic component as primary components.

12. The method according to claim 5, wherein the press-molding is performed stepwise by three steps or more after each layer of raw material mixture is formed.

13. The method according to claim 9, wherein the raw material for forming the rear surface layer is the same as the raw material for forming the front surface layer.

14. The method according to claim 11, wherein the raw material for forming the rear surface layer is the same as the raw material for forming the front surface layer.

15. A press machine for producing an inorganic calcined substance, wherein said press machine comprises an upper portion, a side portion and a lower portion,
wherein said upper portion comprises an upper plate coupled to a press cylinder which is capable of moving up and down in a vertical direction,
wherein said lower portion comprises a lower plate positioned directly below the upper plate and a frame portion positioned outside of the moving space of the press cylinder, wherein at least one of the lower plate and the frame portion are coupled to a piston which is capable of moving up and down in a vertical direction,
wherein said side portion comprises a raw material feeder comprising at least one raw material feeding hopper and at least one raw material feeding member, wherein the at least one raw material feeding hopper is capable of storing a raw material mixture and transferring the raw material mixture to the at least one raw material feeding member, and wherein each of the at least one raw material feeding hopper comprises a valve at a lower end to control flow of the raw material mixture out of the raw material feeding hopper,
wherein the at least one raw material feeding hopper is located outside of moving space of the press cylinder, and the at least one raw material feeding member is capable of moving horizontally in a plane from a position below the at least one raw material feeding hopper to a position above the lower plate and the frame portion when the press cylinder is in an up position.

16. A three layered inorganic calcined substance comprising a front layer, rear layer and core layer,
wherein the front and rear layers each individually comprise, based on total sold content, a hydraulic inorganic material of 15-35 weight %, a vitreous material of 1-15 weight %, a non-plastic material of 2.5-27.5 weight %, a solvent material of 2.5-27.5 weight %, an inorganic fiber of 12-34.9 weight %, an organic fiber of 0.1-3 weight %, a water-soluble resin of 0.1-3 weight %, and a recyclable waste product of 5-50 weight %; and
wherein the core layer comprises, based on total solid content, a hydraulic inorganic material of 15-35 weight %, a vitreous material of 1-15 weight %, an inorganic lightweight material of 4-45 weight %, an inorganic fiber of 12-34.9 weight %, an organic fiber of 0.1-3 weight %, a water-soluble resin of 0.1-3 weight %, an organic lightweight material of 0.1-3 weight %, and a crushed inorganic calcined substance and/or a crushed inorganic non-calcined substance of 5-50 weight %.
